(19) United States
(12) Patent Application Publication
(10) Pub. No.: US 2020/0284087 A1
(43) Pub. Date: Sep. 10, 2020

(54) DEVICE FOR SEALING BELOW DOORS

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 16/063,672

(22) PCT Filed: Nov. 7, 2016
(86) PCT No.: PCT/MX2016/000113

§ 371 Date: Jun. 18, 2018

(30) Foreign Application Priority Data
May 6, 2016 (MX) MX/U/2016/000181

(51) Int. Cl. E06B 7/18

(52) U.S. Cl. CPC E06B 7/18

(57) ABSTRACT

A SEALED DEVICE, THRESHOLD, OR BURLET, COMPRISING A PIECE OF ACTION, AN ALUMINUM CYLINDER, A BARREL CONNECTOR WITH A PUSH PIECE, AN ALUMINUM BAR WITH A CANAL, A RUBBER BAR, A PUSH PIECE, A RIGHT LATERAL PLATE WITH AN ASSEMBLY PLURALITY HOLE, A LEFT LATERAL PLATE WITH AN ASSEMBLY PLURALITY HOLE, TWO GUIDE RIVETS, A BARREL CONNECTOR WITH ACTION PIECE, A FIXING PIECE, AN ALUMINUM CONTAINER BODY, AN ASSEMBLY PLURALITY HOLE, A PLURALITY OF ACCOMMODATION, AN ASSEMBLY SCREW, A UNION HOOK TO THE RUBBER BAR, AND TWO ASSEMBLY-RIVETS.

### TECHNICAL FIELD

THE OBJECT OF THIS INVENTION, THE WAY IT IS EXPRESSED IN THE ANNOUNCED OF THIS DESCRIPTION, IT MAKES REFERENCE TO A SEALED DEVICE, THRESHOLD, OR BURLET.

### PREVIEW OF THE INVENTION

NOWDAYS, ONE CAN FIND TWO CATEGORIES OF SEALED DEVICES, KNOWN AS BURLETS OR THRESHOLDS; THERE ARE DESIGNED FOR DOORS, FOLDING WINDOWS, AND SLIDE DOOR.

BURLETS FOR DOORS AND FOLDING WINDOWS AND CORRIDORS: THEY GET STUCK TO THE HOLE OF THE WINDOW, OR THE DOOR'S CAVITY (HOLE) THAT ONE WANTS TO COVER THEY CAN BE IN OF DIFFERENT MATERIALS.

FOAM: THESE ARE INDICATED FOR MEDIUM AND SMALL CAVITIES FROM 1 TO 4 MM. IT STANDS OUT BY ITS FLEXIBILITY AND IT CAN HAVE A USEFUL LIFE UP TO 5 YEARS.

RUBBER: THEY ARE THE BEST FOR BIG AND MEDIUM SIZE HOLES FROM 2 TO 5 MM. THIS MATERIAL RESISTS THE OUTDOORS AND THE UV RAYS' ACTION. THEY CAN LAST UP TO 5 YEARS AND THEY CAN CONTRIBUTE TO LOWER THE HOME HEATING COSTS.

SILICONE: THIS MATERIAL IS THE BEST INDICATED TO COVER THE CAVITIES' HOLES FROM 1 MM TO 7 MM AND IT OFFERS A MAXIMUM RESISTANCE AND INSULATION. IT LIKELY ALLOWS AN ENERGY SAVINGS. THE LIFETIME FOR THESE QUALITIES IS 10 YEARS; WHERE THE QUALITIES REMAIN INTACT.

BRUSH: IT STICKS TO THE INTERNAL LANES OF THE SLIDING DOORS AND SLIDING WINDOWS AND THEY ALLOW A PERFECT SEALED ON DOORS. THE USEFUL LIFETIME IS UP TO TWO YEARS.

THE PREVIOUS EXAMPLES HAVE AS A LIMITATION THAT THEY DO NOT HAVE A SEALING DEVICE FOR THE MATERIAL TO GO UP OR GO DOWN AT THE MOMENT OF OPENING OR CLOSING THE DOOR; THE DOOR, ALWAYS FIXED, HAS AS A CONSEQUENCE, THEY ARE ALWAYS IN TOUCH WITH THE FLOOR, WHAT HAS A CONSEQUENCE THAT IT GETS MALTED ITSELF, OR THE SEALED MATERIAL, AND WITH TIME, IT DETERIORATES THE FLOOR AS WELL AS THE SEALED MATERIAL, AND THEY ARE NOT REINFORCED WITH RESISTANT MATERIAL.

THE PRESENT INVENTION SEEKS TO SOLVE THIS TECHNICAL PROBLEM BY ADDING A SEALED DEVICE (THE THRESHOLDS, OR BURLETS). ALSO, A HIDDEN SYSTEM IS USED FOR MORE AESTHETICS.

### DESCRIPTION OF THE INVENTION

THE NOVELTY OF THIS INVENTION IS CLEARLY SHOWN IN THE DRAWINGS THAT ARE ATTACHED WITH THE PRESENT APPLICATION, AND ACCORDING TO THE DESCRIPTION THAT BELOW WE DETAINED THAT THE ALPHA-NUMERIC REFERENCES CORRESPOND TO THIS INVENTION'S EACH STRUCTURE'S ELEMENT.

### BRIEF DESCRIPTION OF THE FIGURES

FIG. 1, IS A VIEW IN DISPLAY OF THE SEALED DEVICE, THRESHOLDS, OR BURLET, AND THE STRUCTURAL PARTS THAT IT IS MADE OF.

FIG. 2, IS A SECTIONAL VIEW OF THE SEALED DEVICE, THRESHOLDS, OR BURLET.

FIG. 3, IS A FRONTAL VIEW OF THE SEALED DEVICE, THRESHOLDS, OR INSTALLED BURLET.

### INDETAILED DESCRIPTION OF THE INVENTION

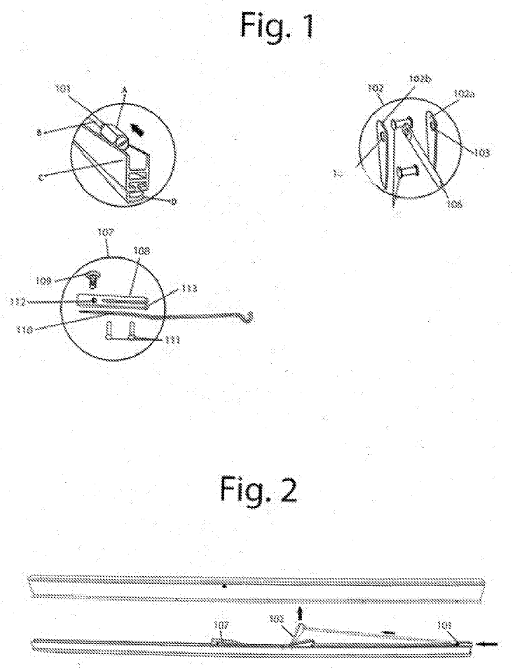

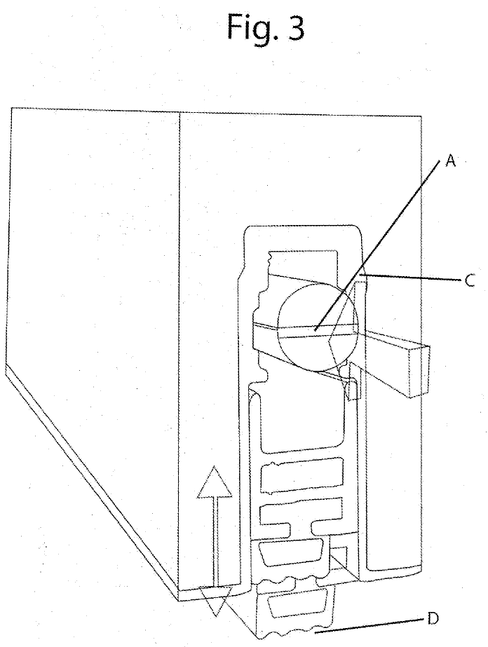

WITH A REFERENCE TO FIG. 1, THE SEALED DEVICE, THRESHOLDS, OR BURLET THAT COMPREHENDS OF AN ACTION PIECE (101) THAT IT LENGTHWISE EXTENDS, CHARACTERIZED BY AN ALUMINUM CYLINDER (A), A 45 SMALL CONNECTING BAR (B) LOCATED ON AN ALUMINUM BAR WITH CANAL (C); THAT IT LENGTHWISE EXTENDS; A RUBBER BAR (D), THAT IT EXTENDS PARRALLELY TO THE ALUMINUM BAR WITH CANAL; A PIECE OF PUSH (102) CHARACTERIZED BECAUSE IT COMPREHENDS A RIGHT LATERAL PLATE (102a) WITH AN ASSEMBLY PLURALITY HOLE (103), A LEFT LATERAL PLATE (102b) WITH AN ASSEMBLY PLURALITY HOLE (104), TWO ASSEMBLY-GUIDE RIVETS (105), A SMALL CONNECTING BAR (106); A FIXING PIECE (107) CHARACTERIZED BECAUSE IT COMPREHENDS AN ALUMINUM CONTAINER BODY (108), THAT IT COMPREHENDS AN ASSEMBLY PLURALITY HOLE (112), A PLURALITY OF ACCOMMODATION (113), AN ASSEMBLY SCREW (109), AN UNION HOOK (110) TO THE RUBBER BAR (D), TWO ASSEMBLY-RIVETS (111).

THE SEALED DEVICE, THRESHOLDS, OR BURLET, IS DESIGNED TO FUNCTION ON DOORS THAT HAVE MINIMUM WIDTH OF 35 MM, AND PERFORATION DEPTH OF 45 MM.

THE FIXING PIECE (107) IS THE ONE THAT ALLOWS THE TOP COVER AND THE RUBBER BAR TO REMAIN UNITED; THE PUSH PIECE (102) LOWERING THE RUBBER BAR (D), WHICH ALLOWS THE SEALED DEVICE'S CORRECT FUNCTIONING.

ONCE INSTALLED THE SEALED DEVICE, (THE THRESHOLDS, OR BURLET) AT THE DOOR IN A CLOSING POSITION, THE FRAME OF THE DOOR PUSHES THE CYLINDER (A) IN THE INTERIOR'S DIRECTION (C); AND IT ACTIVATES THE DESCENDENT MOVEMENT OF THE RUBBER BAR (D).

1. A SEALED DEVICE, THRESHOLD, OR BURLET, COMPRISING:
A PIECE OF ACTION,
AN ALUMINUM CYLINDER,
A BARREL CONNECTOR WITH A PUSH PIECE,
AN ALUMINUM BAR WITH A CANAL,
A RUBBER BAR,
A PUSH PIECE,
A RIGHT LATERAL PLATE WITH AN ASSEMBLY PLURALITY HOLE,
A LEFT LATERAL PLATE WITH AN ASSEMBLY PLURALITY HOLE,
TWO GUIDE RIVETS,
A BARREL CONNECTOR WITH ACTION PIECE,
A FIXING PIECE,
AN ALUMINUM CONTAINER BODY,
AN ASSEMBLY PLURALITY HOLE,
A PLURALITY OF ACCOMMODATION,
AN ASSEMBLY SCREW,
A UNION HOOK TO THE RUBBER BAR, AND
TWO ASSEMBLY-RIVETS.

2. A SEALED DEVICE, THRESHOLDS, OR BURLET ACCORDING TO CLAIM 1, FURTHER COMPRISING:
AN ALUMINUM CYLINDER.

3. A SEALED DEVICE, THRESHOLDS, OR BURLET ACCORDING TO CLAIM 1, FURTHER COMPRISING:
A BARREL CONNECTOR.

4. A SEALED DEVICE, THRESHOLDS, OR BURLET, ACCORDING TO CLAIM 1, FURTHER COMPRISING:
AN ALUMINUM BAR.

5. A SEALED DEVICE, THRESHOLDS, OR BURLET, ACCORDING TO CLAIM 1, FURTHER COMPRISING:
A RUBBER BAR.

6. A SEALED DEVICE, THRESHOLDS, OR BURLET, ACCORDING TO CLAIM 1, FURTHER COMPRISING:
A PUSH PIECE.

7. A SEALED DEVICE, THRESHOLDS, OR BURLET, ACCORDING TO CLAIM 6, FURTHER COMPRISING:
LEFT LATERAL PLATE, AND
RIGHT LATERAL PLATE.

8. A SEALED DEVICE, THRESHOLDS, OR BURLET, ACCORDING TO CLAIM 6, FURTHER COMPRISING:
TWO GUIDE RIVETS.

9. A SEALED DEVICE, THRESHOLDS, OR BURLET, ACCORDING TO CLAIM 6, FURTHER COMPRISING:
A BARREL CONNECTOR.

10. A SEALED DEVICE, THRESHOLDS, OR BURLET, ACCORDING TO CLAIM 1, FURTHER COMPRISING:
A FIXING PIECE.

11. A SEALED DEVICE, THRESHOLDS, OR BURLET, ACCORDING TO CLAIM 10, FURTHER COMPRISING:
A BODY'S CONTAINER.

12. A SEALED DEVICE, THRESHOLDS, OR BURLET, ACCORDING TO CLAIM 10, FURTHER COMPRISING:
AN ASSEMBLY PLURALITY HOLE.

13. A SEALED DEVICE, THRESHOLDS, OR BURLET, ACCORDING TO CLAIM 10, FURTHER COMPRISING:
A PLURALITY OF ACCOMMODATION.

14. A SEALED DEVICE, THRESHOLDS, OR BURLET, ACCORDING TO CLAIM 10, FURTHER COMPRISING:
AN ASSEMBLY SCREW.

15. A SEALED DEVICE, THRESHOLDS, OR BURLET, ACCORDING TO CLAIM 10 FURTHER COMPRISING:
A UNION HOOK.

16. A SEALED DEVICE, THRESHOLDS, OR BURLET, ACCORDING TO CLAIM 10, FURTHER COMPRISING:
TWO ASSEMBLY RIVETS.
